(19) United States
(12) Patent Application Publication
(10) Pub. No.: US 2017/0024147 A1
(43) Pub. Date: Jan. 26, 2017

(54) STORAGE CONTROL DEVICE AND HIERARCHIZED STORAGE CONTROL METHOD

(71) Applicant: FUJITSU LIMITED, Kawasaki-shi (JP)

(72) Inventor: Satoshi Iwata, Yokohama (JP)

(73) Assignee: FUJITSU LIMITED, Kawasaki-shi (JP)

(21) Appl. No.: 15/200,010

(22) Filed: Jul. 1, 2016

(30) Foreign Application Priority Data
Jul. 21, 2015 (JP) 2015-144222

(51) Int. Cl. G06F 3/06; G06F 13/16

(52) U.S. Cl. CPC G06F 3/0611; G06F 13/161; G06F 3/0631; G06F 3/065

(57) ABSTRACT

A storage control device includes a processor configured to monitor access frequency of a write access and a read access each performed on each of a plurality of segments, the write access being performed between previous data reallocation and the present point in time with a write system that writes data in different write areas every time the data is updated, each of the write areas being associated with each of the plurality of segments that are units to logically manage data stored in a plurality of storage devices of different access performance, adjust the access frequency by reducing the access frequency of one segment of the plurality of segments on which the write access is performed, and determine one of the plurality of storage device to store data corresponding to the one segment with the adjusted access frequency on the basis of the adjusted access frequency.

### CROSS-REFERENCE TO RELATED APPLICATION

This application is based upon and claims the benefit of priority of the prior Japanese Patent Application No. 2015-144222, filed on Jul. 21, 2015, the entire contents of which are incorporated herein by reference.

### FIELD

The present specification relates to a storage control device and a hierarchized storage control method.

### BACKGROUND

In recent years, a technology called hierarchical control has been extensively used to improve cost-effectiveness of storage. The hierarchical control is a technology that combines relatively expensive high-speed storage devices and relatively inexpensive low-speed storage devices to achieve a goal of a good balance between price and performance by arranging frequently accessed data in a high-speed storage device and infrequently accessed data in a low-speed storage device.

There is a log-structured data storage technique that writes data in specialized consecutive areas (e.g., see Patent Document 1, Patent Document 2, and Patent Document 3). The log-structured data storage technique does not overwrite the original data when data stored in a storage device is updated, but the original data is kept and the updated data is stored is a location different from the original data.

Patent Document 1: Japanese Laid-Open Patent Publication No. 08-006728

Patent Document 2: Japanese Laid-Open Patent Publication No. 07-200390

Patent Document 3: Japanese Laid-Open Patent Publication No. 09-160813

Non-Patent Document 1: Dushyanth Narayanan et al., “Write Off-Loading: Practical Power Management for Enterprise Storage”, FAST '08: 6th USENIX Conference on File and Storage Technologies, p 253-p 267

### SUMMARY

A storage control device includes a processor configured to monitor access frequency of a write access and a read access each performed on each of a plurality of segments, the write access being performed between previous data reallocation and the present point in time with a write system that writes data in different write areas every time the data is updated, each of the write areas being associated with each of the plurality of segments that are units to logically manage data stored in a plurality of storage devices of different access performance, adjust the access frequency by reducing the access frequency of one segment of the plurality of segments on which the write access is performed, and determine one of the plurality of storage device to store data corresponding to the one segment with the adjusted access frequency on the basis of the adjusted access frequency.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram to explain hierarchical control;

FIG. 2 is a diagram to explain a method of data update in a common data layout;

FIG. 3 is a diagram to explain a method of data update in the log-structured data layout;

FIG. 4 is a diagram to explain an example in which data that is not the latest occupies a storage area of a high-speed storage device;

FIG. 5 illustrates an example of a storage control device according to the present embodiments;

FIG. 6 is a graph to explain giving a penalty (fixed value) to a log-written segment designated to be a log write area according to the present embodiment (Embodiment 1);

FIG. 7 illustrates an example of a storage control device according to the present embodiment (Embodiment 1);

FIG. 8 illustrates an example of the segment management table according to the present embodiment (Embodiment 1);

FIG. 9 illustrates an example of the evaluation value management table according to the present embodiment;

FIG. 10 illustrates an example of an updating flow of the segment management table that occurs when an access is made to a segment according to the present embodiment (Embodiment 1);

FIG. 11 illustrates an example of a flow of segment reallocation processing according to the present embodiment;

FIG. 12 is a diagram to explain a method of giving a penalty in accordance with a log write order in the present embodiment (Embodiment 2);

FIG. 13 is a graph to explain giving a penalty (variable) to segments that are designated to be log write areas and in which log writing is performed according to the present embodiment (Embodiment 2);

FIG. 14 illustrates an example of a storage control device according to the present embodiment (Embodiment 2);

FIG. 15 illustrates an example of the segment management table according to the present embodiment (Embodiment 2);

FIG. 16 illustrates an example of an update flow of the segment management table at the time of data read or data write according to the present embodiment (Embodiment 2);

FIG. 17 illustrates an example of a flow of reallocation processing of segments according to the present embodiment (Embodiment 2);

FIG. 18 illustrates a result of comparison between an access ratio to SSD that uses algorithms to which the present embodiment is not applied and an access ratio to SSD that uses algorithms to which the present embodiment (Embodiment 2) is applied; and

FIG. 19 is an example of a configuration block diagram of a hardware environment of a computer that executes programs according to the present embodiments.

### DESCRIPTION OF EMBODIMENTS

Frequently accessed data is reallocated at regular time intervals because contents of the data may be changed as time passes.

However, a data reallocation technique based on access frequency in the past may not provide expected effects when the log-structured data storage technique is used in the higher level. More specifically, when data update is performed by the log-structured data storage technique, the original data before update may not be accessed in the future.

In such a case, when hierarchical control is carried out in the lower level of the log-structured data storage technique, data stored in a high-speed storage device may be kept stored in the high-speed storage device without being accessed in the future due to data update. As a result, areas in the high-speed storage device may be wastefully occupied.

For that reason, it has been sought to prevent storage areas in storage devices with high access performance from being wastefully occupied by data that may not be accessed in the future as a result of data update.

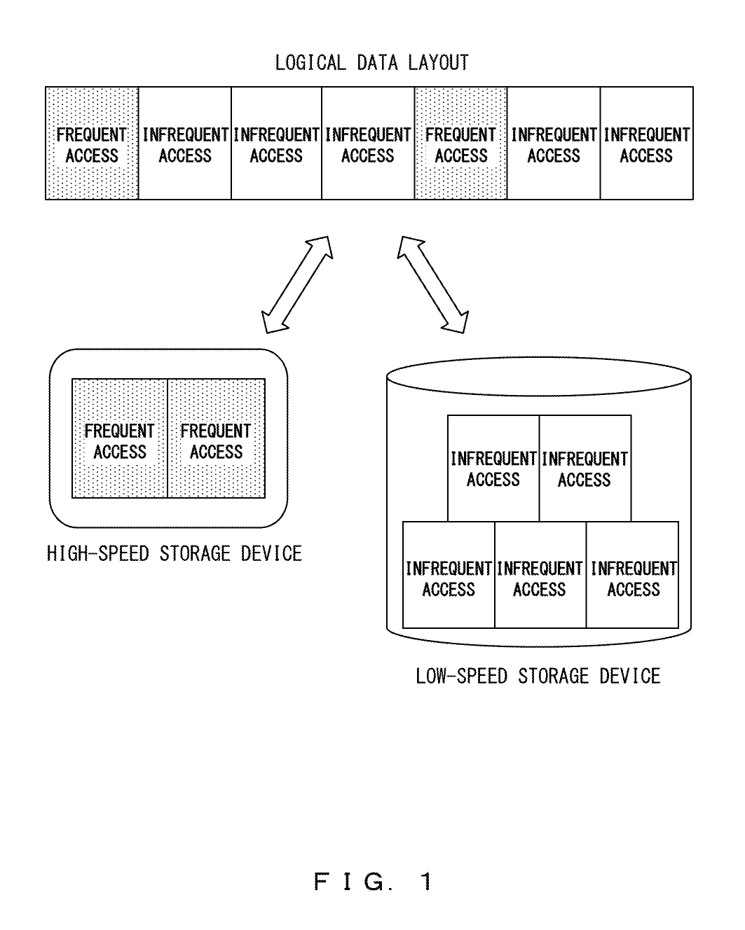

FIG. 1 is a diagram to explain hierarchical control. The hierarchical control provide logical data layout so that users do not have to be aware of the physical presence of a storage device in which data is stored.

The logical data layout is divided into units called segments. The data is logically stored and managed in units of segments by the hierarchical control. A segment is a large unit of several MB to several GB, but an access is performed in a smaller unit of several KB to several hundred KB. Data reallocation is performed in units of segments. When data is allocated in accordance with access frequency, the hierarchical control allocates data corresponding to a frequently accessed segment to a high-speed storage device and data corresponding to an infrequently accessed segment to a low-speed storage device.

When a user makes an access request, the access request is transferred to a storage device that stores the corresponding data based on mapping information that indicates which segment is stored at which position of which storage device.

When frequently accessed data is changed as time passes, it is presumable that the data is reallocated at regular time intervals (e.g., every day or every few hours). For example, a conceivable method is measuring the number of accesses for each segment from the previous reallocation to the present, allocating segments in descending order of the number of accesses in a high-speed storage device until the storage device becomes full in capacity, and allocating the remaining segments in a low-speed storage device.

However, in the case of the above-described data reallocation algorithm based solely on access frequency in the past, expected effects cannot be obtained when log-structured data layout is operated in the higher level. Here, the log-structured data layout is explained.

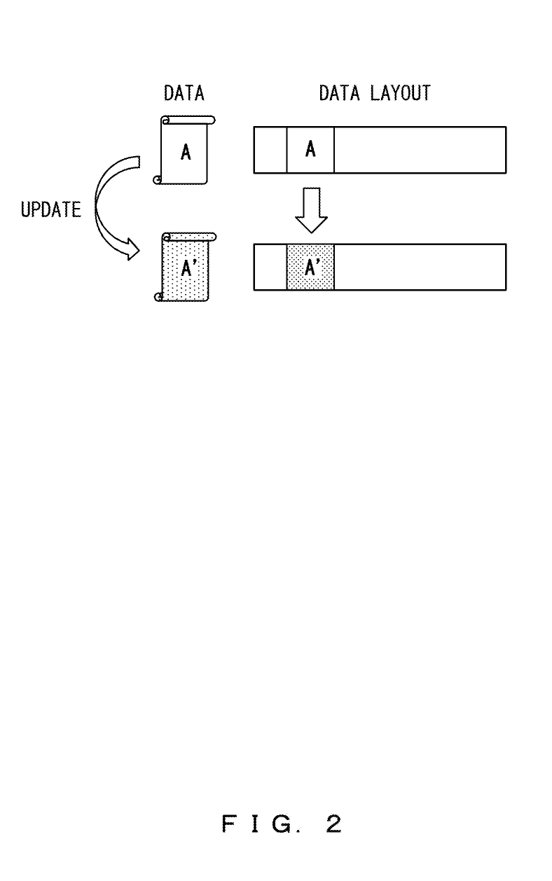

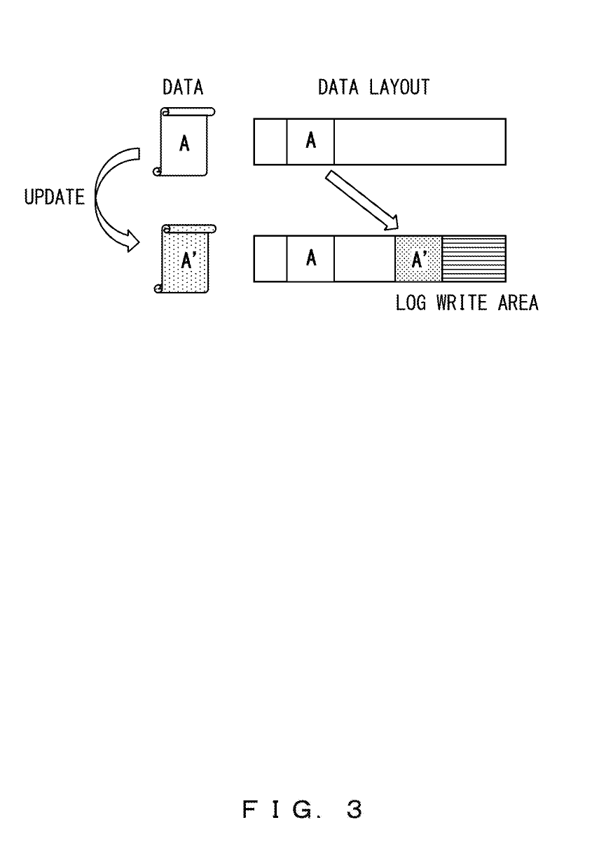

FIG. 2 is a diagram to explain a method of data update in a common data layout. FIG. 3 is a diagram to explain a method of data update in the log-structured data layout. The log-structured data layout is a data management system in which, when data is updated, new data is written in a prescribed log area (hereinafter referred to as “log write area”) rather than overwriting existing data.

As illustrated in FIG. 2, normally, when data is updated from A to A′, the data is overwritten at the position at which the original data is allocated on a data layout.

However, in the log-structured data layout, as illustrated in FIG. 3, the original data is kept stored as it is, but update of the data from A to A′ is realized by writing the data in a prescribed log write area and updating information on a data storage position.

As illustrated in FIG. 3, the log-structured data layout allows writing to be performed in consecutive areas. For that reason, write performance to a hard disk drive (HDD) can be enhanced. In addition, old data before update can be referenced for a certain period of time.

The log-structured data layout treats its data layout as a circular log, writes new data in a log write area, and reuses the tail portion of the log write area as free space. Therefore, when data is written up to the tail of the log-structured data layout, the tail of the log-structured data layout is used again as a log write area.

As described above, in the log-structured data layout, the storage site of the latest data moves as a result of data update. For that reason, the data reallocation technique based solely on access frequency in the past is not suitable as explained below.

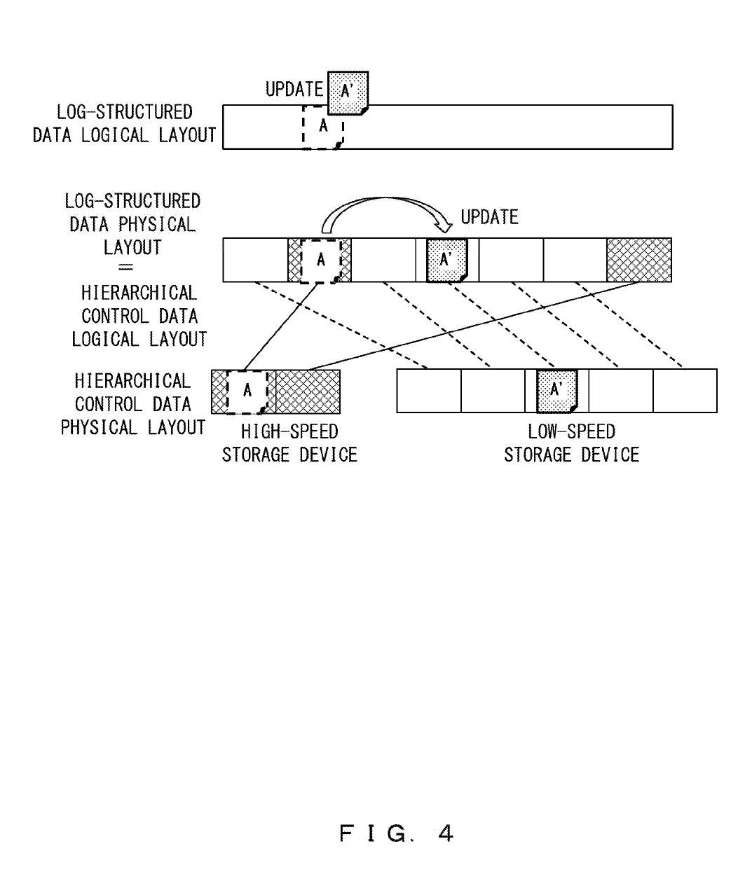

FIG. 4 is a diagram to explain an example in which data that is not the latest occupies a storage area of a high-speed storage device. The log-structured data layout includes a log-structured data logical layout, which is a more logical side, and the log-structured data physical layout, which is a more physical side. A hierarchical control data layout includes a hierarchical control data logical layout, which is a more logical side, and a hierarchical control data physical layout, which is a more physical side. Here, assume that the log-structured data physical layout matches up with the hierarchical control data logical layout.

Here, when data is handled, units to handle data are different in the log-structured data layout and a hierarchical control data logical layout. Data is managed in units of prescribed handling sizes in the log-structured data layout, while in the hierarchical control data logical layout data is managed in units of segments that are units of prescribed handling sizes different from those of the log-structured data layout.

An example is a case in which a segment including data A is determined to be frequently accessed, and the segment is allocated in a high-speed storage device as illustrated in FIG. 4.

Afterwards, when the data A is updated to data A′, in the log-structured data physical layer, an area different from that of the data A (log write area) is designated to the data A′, and the latest data A′ is written in the designated log write area. Then, the data A before update is less likely to be used in the future.

Alternatively, even if data is reallocated to higher-speed storage devices in descending order of access frequency at certain time intervals, when the data A before update is frequently accessed until the data A is updated, the data reallocation is carried out based on the access frequency. As a result, the data A before update is kept stored in the high-speed storage device even though the data A is less likely to be accessed in the future.

As described above, because the area in which the data A is allocated in the high-speed storage device will not be accessed in the future, an area in a high-speed storage device is wastefully occupied.

Considering the above, the present embodiments enhance the use efficiency of the storage device by preventing storage areas in storage devices with high access performance from being wastefully occupied by data that may not be accessed in the future as a result of data update.

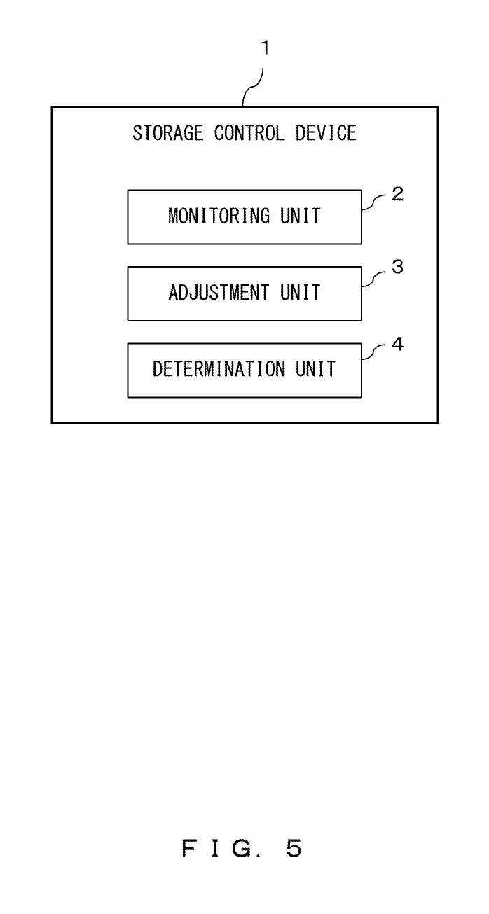

FIG. 5 illustrates an example of a storage control device according to the present embodiments. A storage control device 1 includes a monitoring unit 2, an adjustment unit 3, and a determination unit 4.

The monitoring unit 2 monitors frequencies of write accesses to each of segments and of read accesses to each of the segments within a certain period of time. A segment is a unit to logically manage data stored in plural storage devices of different access performance. A write access is an access performed with a write system that writes data in different write areas every time the data is updated, and each of the write areas corresponds to a segment. A hierarchical control unit 14 described later is one of examples of the monitoring unit 2.

The adjustment unit 3 adjusts access frequency by reducing access frequency to a write-accessed segment. An example of the adjustment unit 3 is the hierarchical control unit 14 described later.

The determination unit 4 determines one of the plural storage devices to be the storage device that stores the data corresponding to the segment of adjusted access frequency based on the adjusted access frequency. The hierarchical control unit 14 described later is also an example of the determination unit 4.

With the above-described configuration, it is possible to enhance use efficiency of the storage device by preventing storage areas in storage devices with high access performance from being wastefully occupied by data that may not be accessed in the future as a result of data update.

The adjustment unit 2 adjusts access frequency by adding prescribed weighting to the access frequency within a prescribed period of time.

With the above-described configuration, when data is reallocated to higher-speed storage devices in descending order of access frequency, it is possible to prevent the original data of updated data from being kept allocated in the high-speed storage device by adjusting access frequency of a segment corresponding to the updated data.

The monitoring unit 2 monitors the order of write access to segments that was write-accessed within a prescribed period of time. At that time, based on the order of write access, the adjustment unit 3 adjusts access frequency by reducing the access frequency in a manner that the access frequency of a segment corresponding to the order of write access is further reduced as a period of time elapsed from the write access becomes longer.

With the above-described configuration, when data is reallocated to higher-speed storage devices in descending order of access frequency, it is possible to prevent data corresponding to a segment that is likely to includes many pieces of original data of updated data that is no longer accessed from being kept allocated in the high-speed storage device.

The determination unit 4 determines that data corresponding to a segment with higher adjusted access frequency is to be stored in a storage device with higher access performance.

With the above-described configuration, data is reallocated in accordance with the adjusted access frequency.

Regarding the present embodiments, more details are explained below. In the data allocation determination method in the storage control device according to the present embodiments, the hierarchical control layer estimates whether many pieces of frequently updated data are included in a segment based on access pattern (e.g., access frequency) of data in order to reallocate data.

More specifically, when calculating an evaluation value that is used to determine a storage device to which data is allocated, the hierarchical control layer gives a penalty to access frequency of a segment that is recently designated to be a log write area so as to lower the frequency. As a result, when access frequency is used as the evaluation value, the evaluation value of the segment that is recently designated to be a log write area is lowered so as to increase the likelihood of data being allocated to a low-speed storage device.

A method of giving a penalty includes a method of giving a fixed value to a segment that is recently designated as a log write area as a penalty and a method of giving a variable in accordance with elapsed time to the segment as a penalty. These two methods are further explained below.

It should be noted that the present embodiments involve a method that focuses on performing as much read processing as possible to high-speed storage devices, but the present embodiments are not involved in write processing. In common data layouts, there is little difference between read and write.

However, in the log-structured data layout, two types of processing (read and write) are very different. This is because data read is carried out at the position of the latest data, while data write is carried out at a log write area.

Therefore, in order for write processing to be performed in a high-speed storage device, the log write area needs to be allocated in the high-speed storage device before the write processing starts. To achieve this, a position of the log write area needs to be reported from the log-structured data layer, or in the case of no report from the log-structured data layer, the hierarchical control layer on its own estimates the next log write area from an access pattern at the time of garbage collection.

As described above, when a log-structured data layout operates in the higher level than a hierarchical control layer, read and write need to be separately considered, and the present embodiments focus on read processing.

### Embodiment 1

In Embodiment 1, a method of giving a fixed value as a penalty to a segment that is recently designated to be a log write area to lower access frequency is explained.

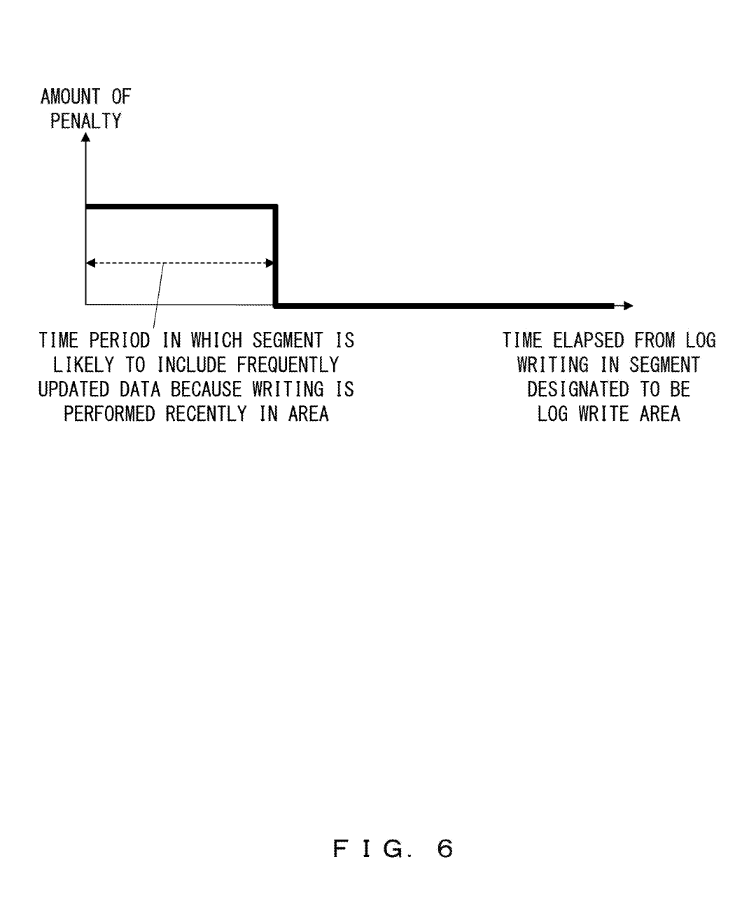

FIG. 6 is a graph to explain giving a penalty (fixed value) to a log-written segment designated to be a log write area according to the present embodiment (Embodiment 1). In FIG. 6, the amount of penalty is on the vertical axis. The elapsed time from log writing in the segment designated to be a log write area is on the horizontal axis.

For a segment designated to be a log write area, a penalty (fixed value >1) is given to the access frequency of the segment at the time of the first reallocation. The penalty is given because the segment is likely to include frequently updated data until the first reallocation.

After data reallocation, the penalty is initialized and therefore the amount of penalty becomes “0”.

Here, in a segment that is recently designated to be a log write area, data that is recently updated is stored. Not all pieces of data are updated in the same manner at the same frequency, but frequently updated data and infrequently updated data are mixed in the segment.

In other words, a log write area to which writing is performed recently includes a number of pieces of frequently updated data that is likely to be no longer accessed because the data has been updated or that will be no longer accessed in the near future.

Accordingly, a segment that is recently designated to be a log write area, even if its read frequency is high, should not be proactively allocated to a high-speed storage device.

However, data that should be allocated in a high-speed storage device may be included in the recently log-written segments. For example, such data is infrequently updated data that happen to be updated this time and frequently updated data that has overwhelmingly high read frequency.

Considering this, segments that are recently designated to be log write areas are not always allocated to a low-speed storage device, but an opportunity of being allocated in a high-speed storage device is provided by giving a penalty to the read frequency when an evaluation value is calculated from the read frequency.

An evaluation formula to give a penalty is provided below.

Evaluation Formula(at the time of giving a penalty)=read_num×1/const

The number of reads in each segment: read_num
Fixed value: const fixed value

On the other hand, a penalty is not imposed on a segment that is not designated to be a log write area. In such a case, read access frequency of the segment itself is the evaluation value of the segment.

Consequently, the evaluation value of a segment that is designated to be a log write area can be kept relatively lower than the evaluation value of a segment that is not designated to be a log write area. As a result, when data is allocated to higher-speed storage devices in descending order of access frequency, it is possible to prevent the possibility that segments designated to be log write areas are allocated to a high-speed storage device.

As described above, in Embodiment 1, the hierarchical control layer adjusts access frequency by giving a penalty to read access frequency at the time of calculating an evaluation value of a segment in accordance with whether or not writing is performed in a corresponding log write area. The hierarchical control layer reallocates data based on the adjusted access frequency. As a result, the hierarchical control layer can determine data allocation in consideration of not only read frequency but also estimated update frequency without receiving information from the log-structured data layer.

Further detailed example is provided below.

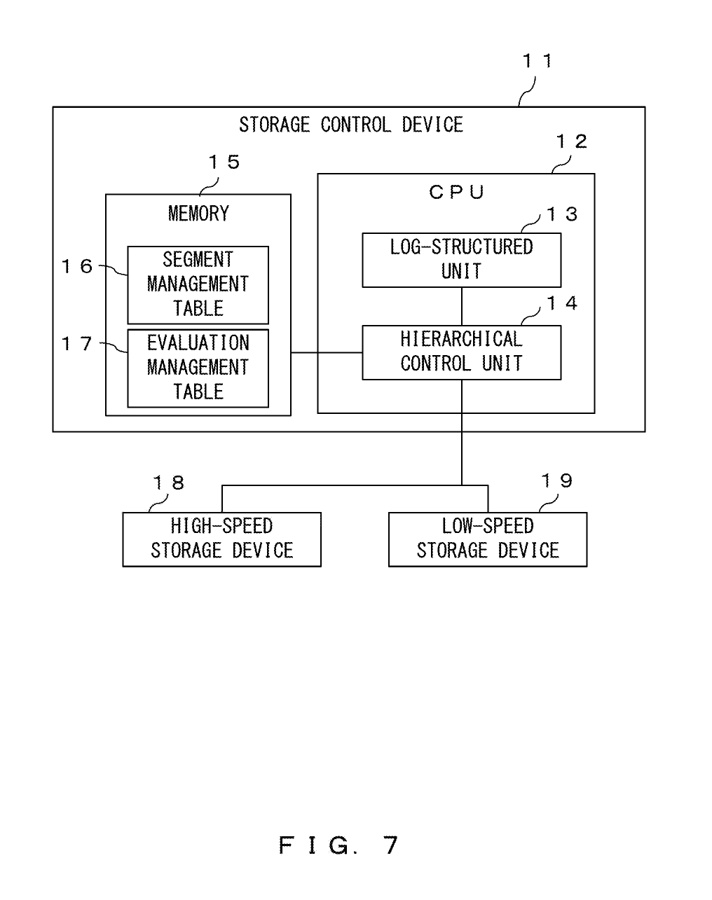

FIG. 7 illustrates an example of a storage control device according to the present embodiment (Embodiment 1). The storage control device 11 includes CPU 12, a memory 15, a high-speed storage device 18, and a low-speed storage device 19.

CPU (Central Processing Unit) 12 is a processor that controls the entirety of the storage control device 11. CPU 12 functions as a log-structured unit 13 and a hierarchical control unit 14 by reading and executing log-structured software and hierarchical control software that are stored in a storage device (not illustrated).

As explained in FIG. 3, the log-structured unit 13, when data is updated, writes the updated data in a log write area and keeps data before update as it is in accordance with the log-structured data layout.

As explained in FIG. 1, the hierarchical control unit 14, by using logical data layout divided into segments, performs a control to allocate frequently accessed segments to the high-speed storage device 18 and infrequently accessed segments to the low-speed storage device 19. When an access request is made, the hierarchical control unit 14 transfers the access request to a storage device that stores the corresponding data based on mapping information (not illustrated) that indicates which segment is stored at which position in which storage device.

The memory 15 is a storage device that temporarily stores data. The memory 15 stores a segment management table 16, an evaluation value management table 17, the mapping information that is not illustrated, and the like. The segment management table 16 and the evaluation value management table 17 are managed by the hierarchical control unit 14.

The high-speed storage device 18 is a storage device that enable data read/write at high speed, and an SSD (Solid State Drive) is an example. The low-speed storage device 19 is a storage device with slower read/write speed than the high-speed storage device 18, and an HDD is an example.

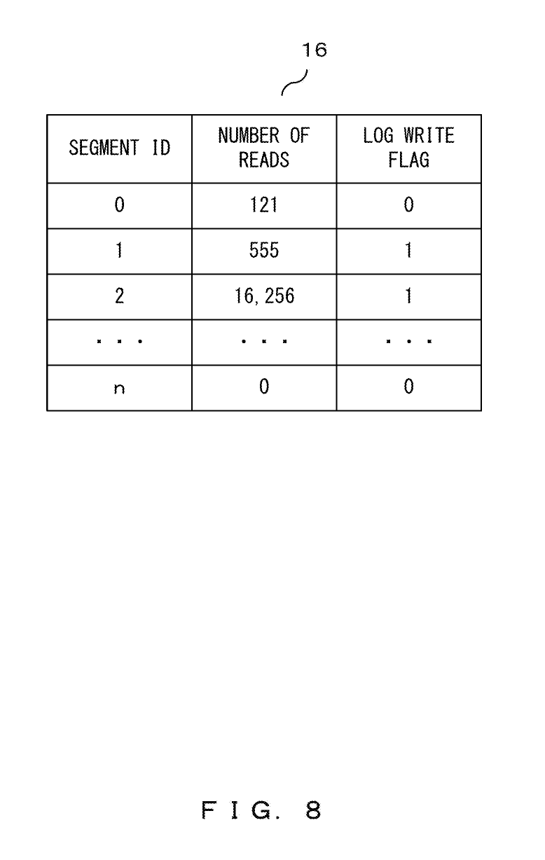

FIG. 8 illustrates an example of the segment management table according to the present embodiment (Embodiment 1). The segment management table 16 includes items such as “segment ID”, “number of reads”, and “write flag”. “Segment ID” stores a segment ID that identifies a segment in the logical data layout that is divided into segments. “Number of reads” stores the number of reads in the segment. “Write flag” stores whether or not log writing is performed in a log write are corresponding to the segment. The initial value of the flag is set to “0” as a value indicating that log writing is not performed in the log write area corresponding to the segment. When log writing is performed in the log write area of the segment, the flag is updated to “1”.

First, as illustrated in FIG. 8, the hierarchical control unit 14 records the number of reads in segments for each segment. Because the most recent value needs to be counted for this number of reads, when data is reallocated, the hierarchical control unit 14 resets “number of reads” for all of the segments in the segment management table 16 to “0”.

Regarding a segment in which data is written in a log write area, the hierarchical control unit 14 sets the flag of the segment to “1” in the segment management table 16. In the same manner, at the time of writing to a log write area, when data is reallocated, the hierarchical control unit 14 resets “write flag” to “0” for all of the segments in the segment management table 16.

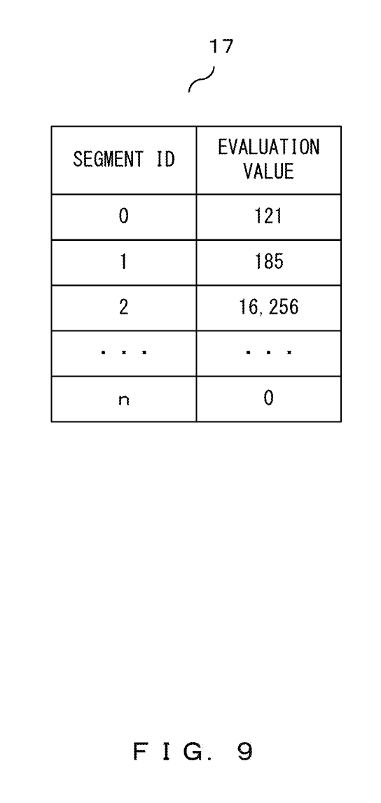

FIG. 9 illustrates an example of the evaluation value management table according to the present embodiment. The evaluation value management table 17 includes items such as “segment ID” and “evaluation value”. “Segment ID” stores a segment ID. “Evaluation value” stores the number of read in the segment or a value calculated from the number of reads in the segment and a penalty as an evaluation value.

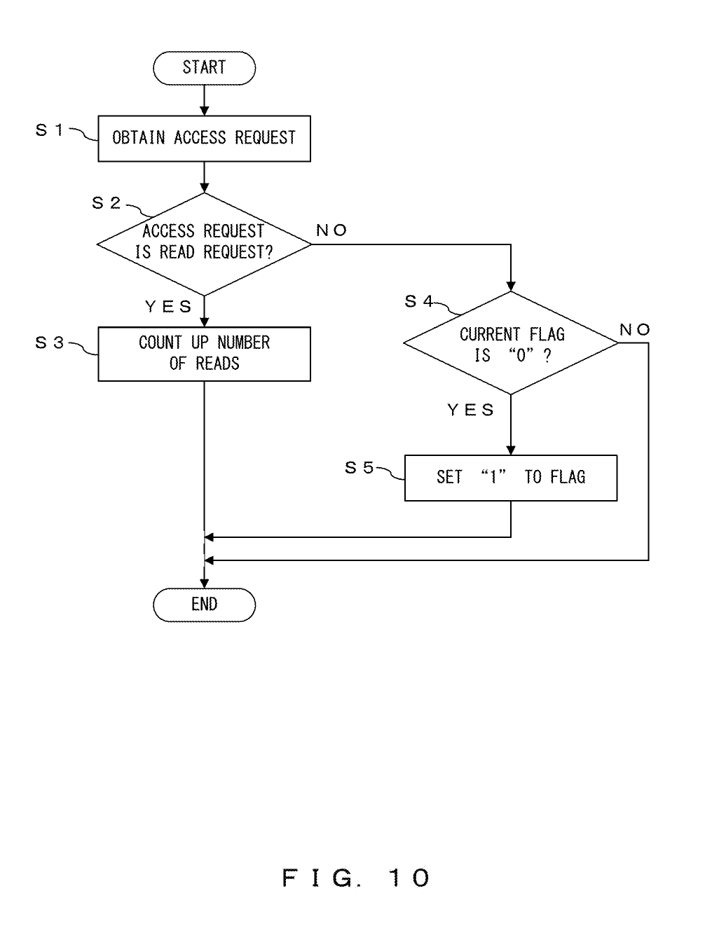

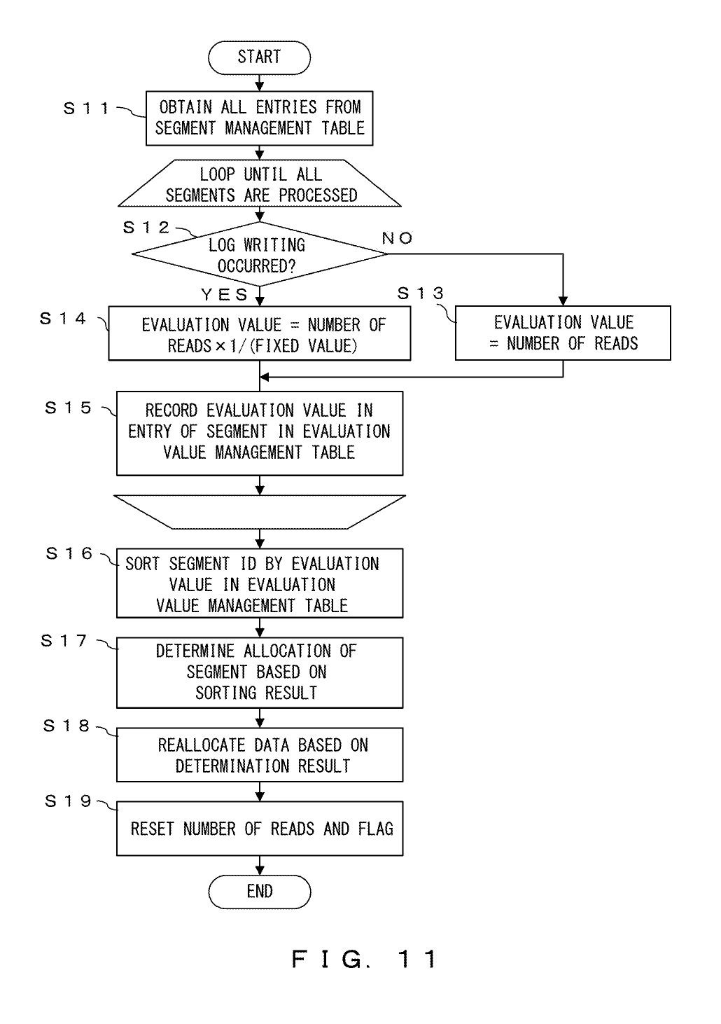

Next, operations of the storage control device 11 in Embodiment 1 are explained with reference to FIG. 10 and FIG. 11.

FIG. 10 illustrates an example of an updating flow of the segment management table that occurs when an access is made to a segment according to the present embodiment (Embodiment 1).

The hierarchical control unit 14 obtains an access request to data from the log-structured unit 13 (S1). When the obtained access request is a read request (“YES” in S2), the hierarchical control unit 14 identifies the corresponding segment ID from the read request. The hierarchical control unit 14 counts up “number of reads” corresponding to the identified segment ID in the segment management table 16 (S3).

When the obtained access request is a write request “NO” in S2), the hierarchical control unit 14 identifies a segment ID corresponding to the write request. When a flag corresponding to the identified segment ID is “0” in the segment management table 16 (“YES” in S4), the hierarchical control unit 14 updates the flag value to “1” (S5).

Next, reallocation processing of a segment is explained. An example of a method that allows the hierarchical control unit 14 to detect that a segment is designated to be a log write area is a method in which once writing occurs in a segment, the segment is regarded as being designated to be a log write area.

However, even in a log-structured data layout, writing other than log writing may occur for management of metadata. In such a case, to detect data write is detected separately from the metadata write, the hierarchical control unit 14 may detect only a segment in which a prescribed amount or more of writing is performed in consecutive areas as a log write area.

When data is reallocated, an evaluation value is calculated to determine data allocation by using the segment management table 16 in FIG. 8.

FIG. 11 illustrates an example of a flow of segment reallocation processing according to the present embodiment. The hierarchical control unit 14 obtains all entries (“segment ID”, “number of reads”, and “write flag”) from the segment management table 16 (S11).

The hierarchical control unit 14 performs processing in S12 to S15 explained below for each entry. It should be noted that in the processing in S12 to S15, an entry that is to be processed is referred to as a target entry.

The hierarchical control unit 14 decides whether or not writing in a log write area corresponding to a segment of the target entry occurred, or in other words, decides whether or not the flag included in the target entry is “1” (S12).

When writing to the log write area has occurred (when the flag=1) (“YES” in S12), the hierarchical control unit 14 calculates an evaluation value by multiplying “number of reads” read_num included in the target entry by an inverse number of the penalty (=1/const) (S14).

When writing to the log write area has not occurred (when the flag=0), (“NO” in S12), the hierarchical control unit 14 sets the evaluation value to be equal to “number of reads” included in the target entry (S13).

The hierarchical control unit 14 records the evaluation value of the segment obtained in S13 or in S14 in the entry of the corresponding segment ID in the evaluation value management table 17 (S15).

After the processing in S12 to S15 is ended for all entries registered in the segment management table 16, the hierarchical control unit 14 sorts the segment IDs in the evaluation value management table 17 in descending order of the evaluation value (S16).

Based on the evaluation value management table 17, the hierarchical control unit 14 determines that segments are allocated in a high-speed storage device 18 in descending order of evaluation value, and the remaining segments are allocated in the low-speed storage device 19 (S17).

Based on the result of the determination, the hierarchical control unit 14 allocates segments in the high-speed storage device 18 in descending order of evaluation value and the remaining segments in the low-speed storage device 19 (S18).

The hierarchical control unit 14 initializes the number of reads and the flag for every entry in the segment management table 16 by setting them to “0” (S19).

### Embodiment 2

In Embodiment 1, access frequency is adjusted by giving a penalty (fixed value) at the time of calculating an evaluation value of a segment depending on whether or not writing is performed in a log write area corresponding to the segment. Meanwhile, in addition to the adjustment in Embodiment 1, Embodiment 2 further adjusts access frequency by changing the amount of penalty in accordance with the elapsed time from the log writing. It should be note that in Embodiment 2, structures, functions, or processing that are the same as those in Embodiments 1 are assigned with the same reference numerals, and the explanations of those same structures, functions, or processing are omitted.

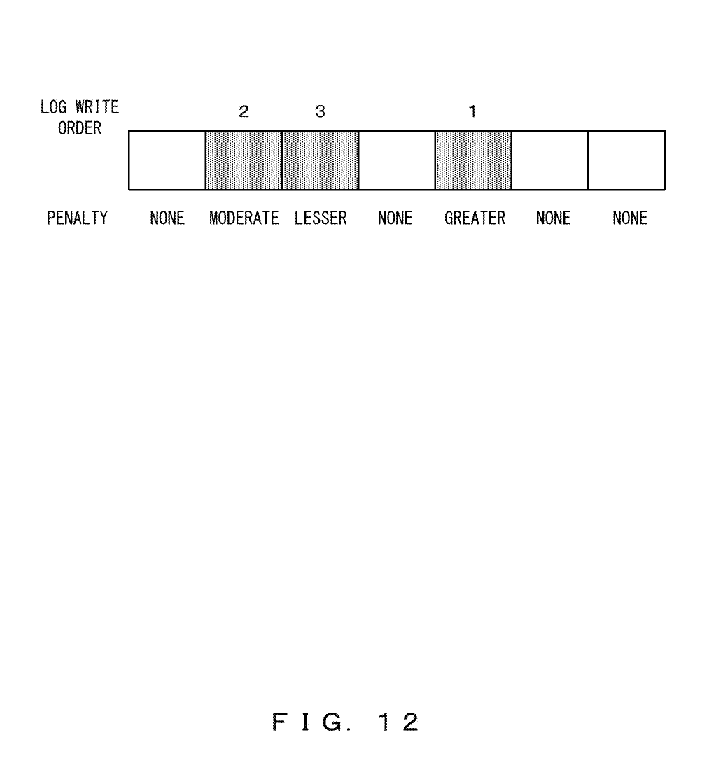

FIG. 12 is a diagram to explain a method of giving a penalty in accordance with a log write order in the present embodiment (Embodiment 2). In FIG. 12, an example is given such that the hierarchical control layer divides a data space into seven segments and manages the segments. It should be noted that in FIG. 12, each segment and a log write area that is a write unit designated at the time of log writing are in the same size for the purpose of explanation, but the size can be different.

This example represents that after execution of previous data reallocation, Three segments have been designated so far (until the current reallocation decision) to be log write areas by the log-structured data layer in the order described on the segments (log write order).

In this case, as illustrated in FIG. 12, the hierarchical control layer sets the evaluation value to be equal to the read frequency itself without giving a penalty to segments that are not designated to be log write areas by the log-structured data layer.

On the other hand, the hierarchical control layer calculates the evaluation value of the segments designated to be log write areas by giving a greater penalty to read frequency in the order of log writing.

The hierarchical control layer allocates segments to a high-speed storage device in descending order of calculated evaluation values of each segment, and allocates the remaining segments to a low-speed storage device.

As described above, in Embodiment 2, the hierarchical control layer adjusts access frequency by giving a penalty to read access frequency in accordance with the log write order at the time of calculating an evaluation value of a segment designated to be a log write area. The hierarchical control layer reallocates data base on the adjusted access frequency. As a result, the hierarchical control layer can determine data allocation in consideration of not only read frequency but also estimated update frequency without receiving information from the log-structured data layer.

Here, when the segments in which writing is performed in the log write area after the previous reallocation are compared with one another, a segment being earlier in the write order implies that because relatively long time has elapsed from data writing and therefore the data may have been overwritten, the latest data is not likely to exist. On the other hand, a segment being later in the write order implies that because the time that has elapsed from data writing is relatively short, the latest data is likely to exist. Therefore, greater penalty is given to a segment in which writing is performed earlier.

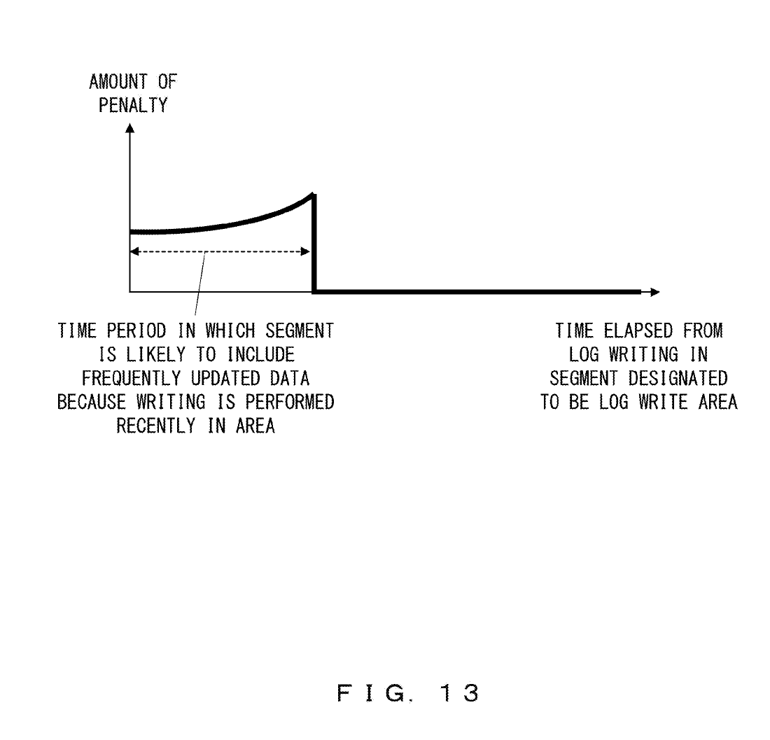

FIG. 13 is a graph to explain giving a penalty (variable) to segments that are designated to be log write areas and in which log writing is performed according to the present embodiment (Embodiment 2). In FIG. 13, the amount of penalty is on the vertical axis. The elapsed time from log writing in the segment designated to be a log write area is on the horizontal axis.

As illustrated in FIG. 13, an amount of penalty is given to the segment corresponding to data written in the log write area during a prescribed period of time from a point in time at which data corresponding to the segment is written in the log write area. Here, the prescribed period of time is a time period from log writing to data reallocation.

In the case of FIG. 13, during the prescribed period of time from the point in time at which data corresponding to the segment is written in the write area, the amount of penalty increases exponentially or in an nth-degree curve manner as time passes. It should be noted that during the prescribed period of time from the point in time at which data corresponding to the segment is written in the write area, the amount of penalty may be increased linearly as time passes.

In addition, after the prescribed period of time, the amount of penalty becomes 0. This is because the penalty is initialized by the segment reallocation processing. As a result of the segment reallocation, frequently used segments are allocated in a high-speed storage device.

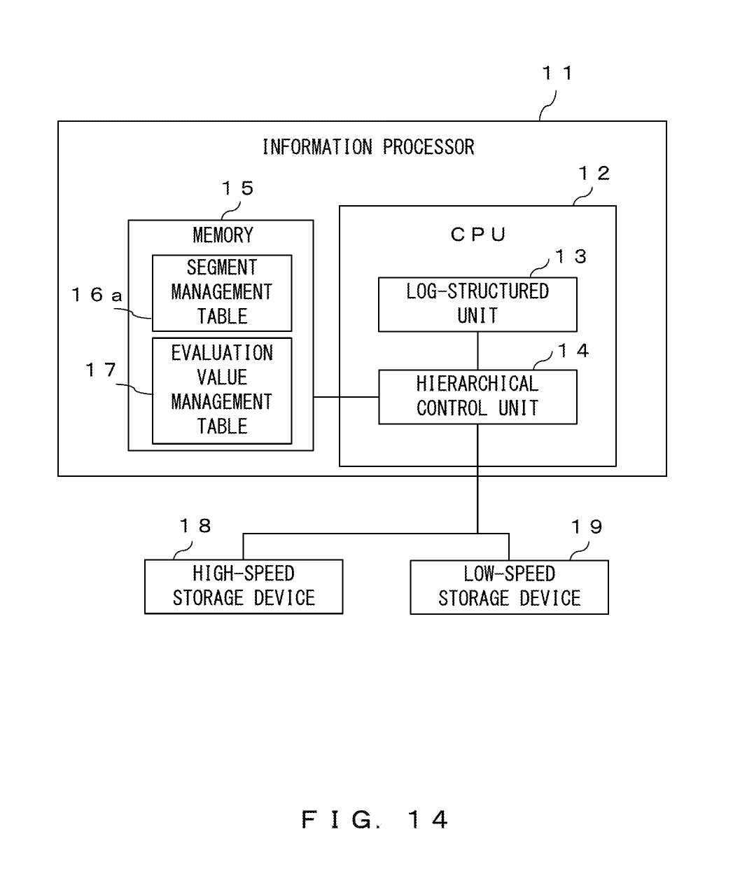

FIG. 14 illustrates an example of a storage control device according to the present embodiment (Embodiment 2). The storage control device 11 in FIG. 14 has the segment management table 16 replaced with a segment management table 16a. The rest of the configuration is the same as that of FIG. 7.

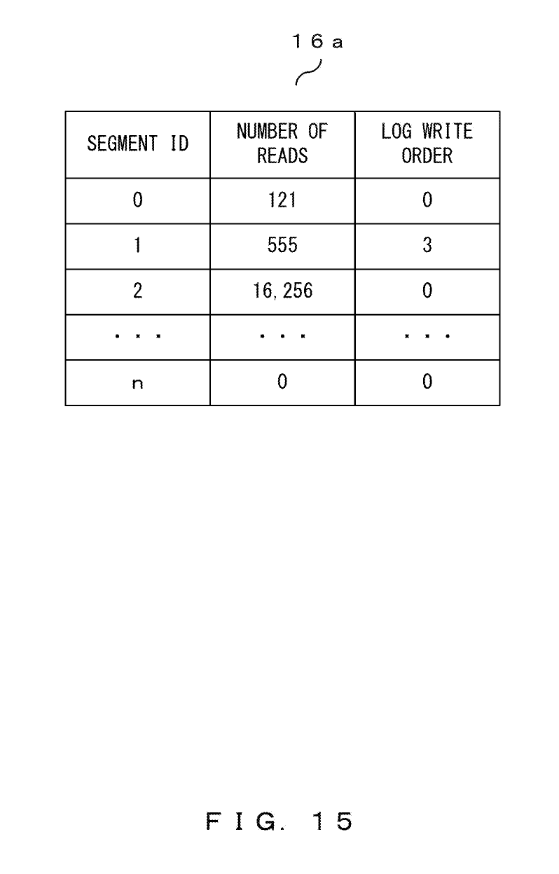

FIG. 15 illustrates an example of the segment management table according to the present embodiment (Embodiment 2). The segment management table 16a includes items such as “segment ID”, “number of reads”, and “log write order”. “Segment ID” stores a segment ID that identifies a segment in the logical data layout that is divided into segments. “Number of reads” stores the number of reads in the segment. “Log write order” stores the order of writing in a log write area of the segment. The initial value of “number of reads” and “log write order” is set to “0”.

First, as illustrated in FIG. 15, the hierarchical control unit 14 records the number of reads of segments for each segment. Because the most recent value needs to be counted for this number of reads, when data is reallocated, the hierarchical control unit 14 resets “number of reads” for all of the segments in the segment management table 16a to “0”.

Regarding a segment in which data is written in a log write area, as illustrated in FIG. 15, the hierarchical control unit 14 records the log write order of the corresponding segment in the segment management table 16a. In the same manner, at the time of writing to a log write area, when data is reallocated, the hierarchical control unit 14 resets “log write order” to “0” for all of the segments in the segment management table 16a.

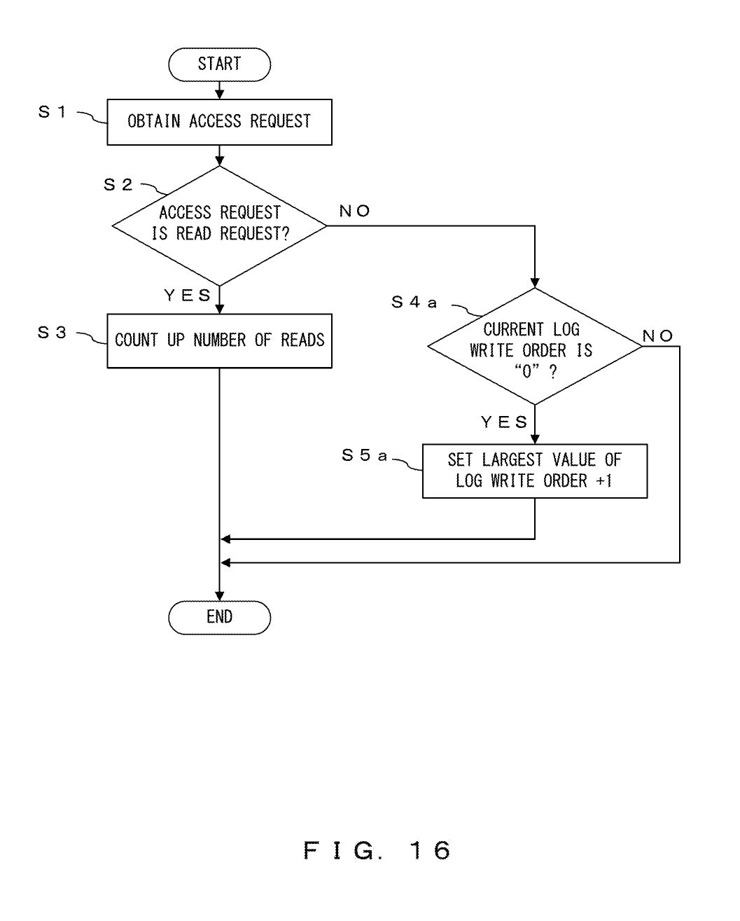

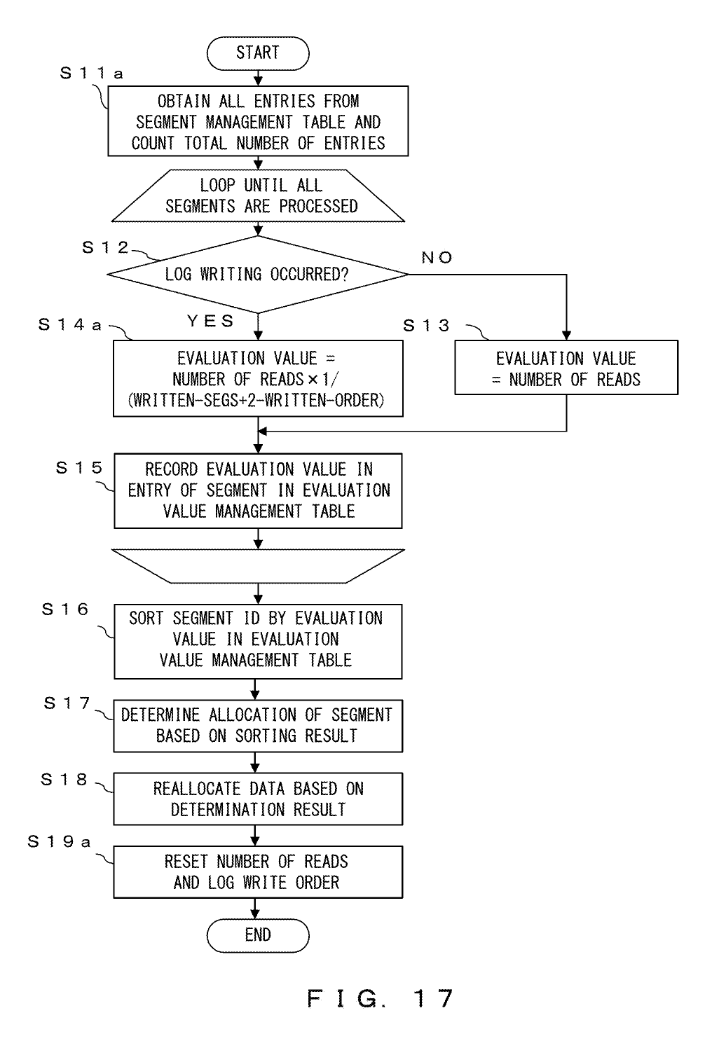

Next, operations of the storage control device 11 according to Embodiment 2 are explained with reference to FIG. 16 and FIG. 17.

FIG. 16 illustrates an example of an update flow of the segment management table at the time of data read or data write according to the present embodiment (Embodiment 2). The flow in FIG. 16 has S4 and S5 in FIG. 10 replaced with S4a and S5a, respectively. In the following descriptions, a case in which the obtained access request is a write request is explained, and an explanation of a case in which the obtained access request is a read request is omitted.

When the obtained access request is a write request (“NO” in S2), the hierarchical control unit 14 identifies the corresponding segment ID from the write request. When the log write order corresponding to the identified segment ID is “0” in the segment management table 16a (“YES” in S4a), the hierarchical control unit 14 obtains the largest number of the log write order from the column “log write order” in the segment management table 16a. The hierarchical control unit 14 sets the log write order corresponding to the identified segment ID in the segment management table 16a to a value calculated by adding 1 to the obtained largest log write order (S5a).

Next, reallocation processing of a segment is explained. An example of a method that allows the hierarchical control unit 14 to detect that a segment is designated to be a log write area is a method in which once writing occurs in a segment, the segment is regarded as being designated to be a log write area.

However, even in a log-structured data layout, writing other than log writing may occur for management of metadata. In such a case, to detect data write is detected separately from the metadata write, the hierarchical control unit 14 may detect only a segment in which a prescribed amount or more of writing is performed in consecutive areas as a log write area.

When data is reallocated, an evaluation value is calculated to determine data allocation by using the segment management table 16a.

First, regarding the evaluation value of a segment with the log write order being 0 (i.e., log writing was not performed), the number of reads itself is the evaluation value.

On the other hand, the evaluation value of a segment with the log write order being other than 0 (i.e., log writing was performed) is processed as below. For example, the evaluation value of the last segment designated to be a log write area is a value obtained by multiplying the number of reads by ½, the evaluation value of second to the last segment designated to be a log write area is a value obtained by multiplying the number of read by ⅓, . . . , and the evaluation value of nth to the last segment designated to be a log write area is a value obtained by multiplying the number of read by 1/(n+1).

Consequently, lesser penalty is given to a segment that is later in order of designation to be log write area.

An evaluation formula to give a penalty is provided below.

Evaluation Formula(at the time of giving a penalty)=read_num×1/(written_segs+2-written_order)

The number of reads in each segment: read_num
Total number of segments in which writing occurred after the previous reallocation: written_segs
The order of writing in each segment: written_order

At the time of determining reallocation, segments are allocated to a high-speed storage device in descending order of the above evaluation value, and the remaining segments are allocated to a low-speed storage device. Details of the above procedures are explained with reference to FIG. 17.

FIG. 17 illustrates an example of a flow of reallocation processing of segments according to the present embodiment (Embodiment 2). The flow in FIG. 17 has S11, S14, and 19, in the flow in FIG. 11 replaced with S11a, S14a, and S19a, respectively.

The hierarchical control unit 14 obtains all entries (“segment ID”, “number of reads”, and “log write order”) from the segment management table 16a (S11a). At that time, the hierarchical control unit 14 checks the number of all entries obtained and sets the largest number of the entries in “log write order” to the written_segs.

The hierarchical control unit 14 performs the processing in S12 to S15 explained below for each entry. It should be noted that in the processing in S12 to S15, an entry that is to be processed is referred to as a target entry.

The hierarchical control unit 14 decides whether or not writing in a log write area corresponding to a segment of the target entry occurred, or in other words, decides whether or not “log write order” included in the target entry is other than 0 (S12).

When writing to the log write area has occurred (when “log write order” is other than 0) (“YES” in S12), the hierarchical control unit 14 performs the following processing.

Specifically, the hierarchical control unit 14 calculates an evaluation value by multiplying “number of reads” read_num included in the target entry by an inverse number of the penalty (1/(written_segs+2-written_orer)) (S14a).

When writing to the log write area has not occurred (when “log write order”=0) (“NO” in S12), the hierarchical control unit 14 sets the evaluation value to be equal to “number of reads” included in the target entry (S13).

The hierarchical control unit 14 records the evaluation value of the segment obtained in S13 or in S14a in the entry of the corresponding segment ID in the evaluation value management table 17 (S15).

After the processing in S12 to S15 is ended for all entries registered in the segment management table 16a, the hierarchical control unit 14 sorts the segment IDs in the evaluation value management table 17 in descending order of the evaluation value (S16).

Based on the evaluation value management table 17, the hierarchical control unit 14 determines that segments are allocated in a high-speed storage device 18 in descending order of evaluation value, and the remaining segments are allocated in the low-speed storage device 19 (S17).

Based on the result of the determination, the hierarchical control unit 14 allocates segments in the high-speed storage device 18 in descending order of evaluation value and the remaining segments in the low-speed storage device 19 (S18).

The hierarchical control unit 14 initializes the number of reads and the log write order for every entry in the segment management table 16a by setting them to “0” (S19a).

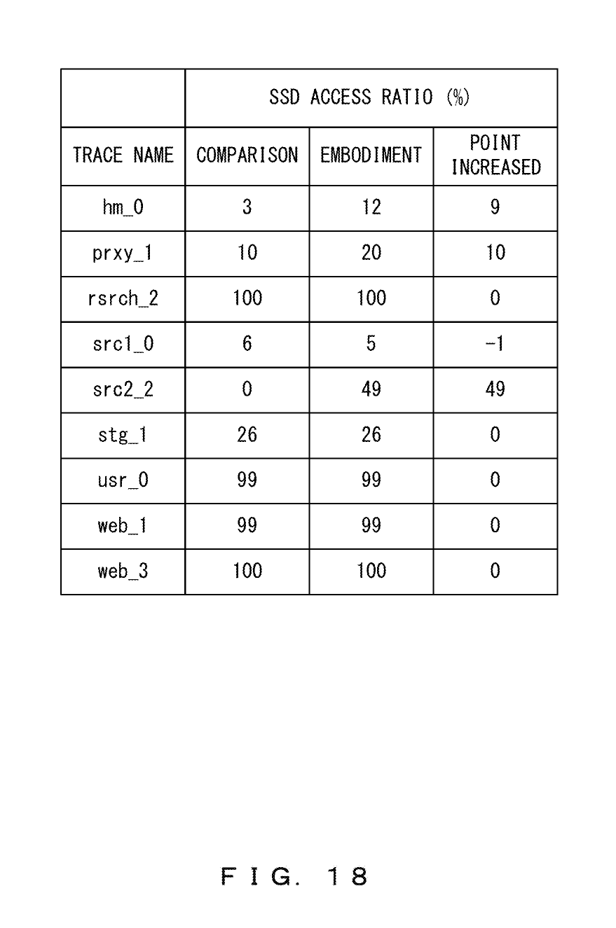

FIG. 18 illustrates a result of comparison between an access ratio to SSD that uses algorithms to which the present embodiment is not applied and an access ratio to SSD that uses algorithms to which the present embodiment (Embodiment 2) is applied. In this comparative experiment, algorithms to which the present embodiment is not applied and algorithms to which the present embodiment is applied are each evaluated through simulations.

In the evaluation, software for managing data with the log-structured data layout is operated in the higher level, hierarchical control software is operated in its lower level, and trace data for simulation is obtained. SSD is used as a high-speed storage device and HDD is used as a low-speed storage device.

For loading, storage trace data of enterprise services that is disclosed by Microsoft Research Cambridge (see Non-Patent Document 1) is given. This set of storage trace data includes 36 types of traces, and among the 36 types, 9 types of trace data with write ratio being 30% to 70% are evaluated.

It should be noted that in order to evaluate the present embodiments that include some write requests that give characteristic operations in the log-structured data layout, and that focuses on enhancing the speed of read processing, these 9 types of traces are selected from the aspect of including a certain number of read requests.

In the evaluation, highly loaded two hours in each trace data are extracted and are replayed twice. Data allocation is determined from the access pattern in the first replay, and a ratio of access to SSD in the access pattern in the second replay is measured.

When the size of a segment for hierarchical control is 1 GB and the size of SSD is 20% of the size of volume in each trace, the result of comparison of the SSD access ratio for each trace between algorithms to which the present embodiment is not applied and algorithms to which the present embodiment (Embodiment 2) is applied is provided in FIG. 18. Here, the algorithms to which the present embodiment is not applied are algorithms for allocating segments to a high-speed storage device in descending order of the counted number of reads without a penalty in accordance with the order used for log writing.

In the result of comparison in FIG. 18, the SSD access ratio was increased by the method according to the present embodiment (Embodiment 2) in 3 of the 9 types of traces, and decrease was observed in only one type of traces. The number of points increased in the SSD access ratio was 67 points in total, and when focusing only on the 4 types of traces that were increased/decreased, the SSD access ratio increased by about 17 points in average. Therefore the result suggests that more appropriate data allocation that of the existing approach can be achieved according to the present embodiment (Embodiment 2) in the environment in which the log-structured data layout operates in the higher level.

According to the present embodiment (Embodiment 2), when the log-structured data layout is operating in the higher level at the time of storage hierarchical control, the storage hierarchical control layer can carry out the following processing. Specifically, the storage hierarchical control layer determines data allocation based not only on access frequency to data but also on update frequency without receiving information from the log-structured data layer.

More specifically, when calculating an evaluation value to determine data allocation, the storage hierarchical control layer gives a penalty to the evaluation value based on the access frequency to data and in accordance with the order of log writing in areas in which log writing is performed recently. Consequently, it is possible to decrease the possibility of having a high-speed storage device store data that is likely to be no longer accessed in the future due to update of the data. As a result, it is possible to prevent areas in high-speed storage devices from being occupied by wasteful data.

It should be noted that the penalty used in Embodiments 1 and 2 is merely an example, and it is not limited to the above-described penalty.

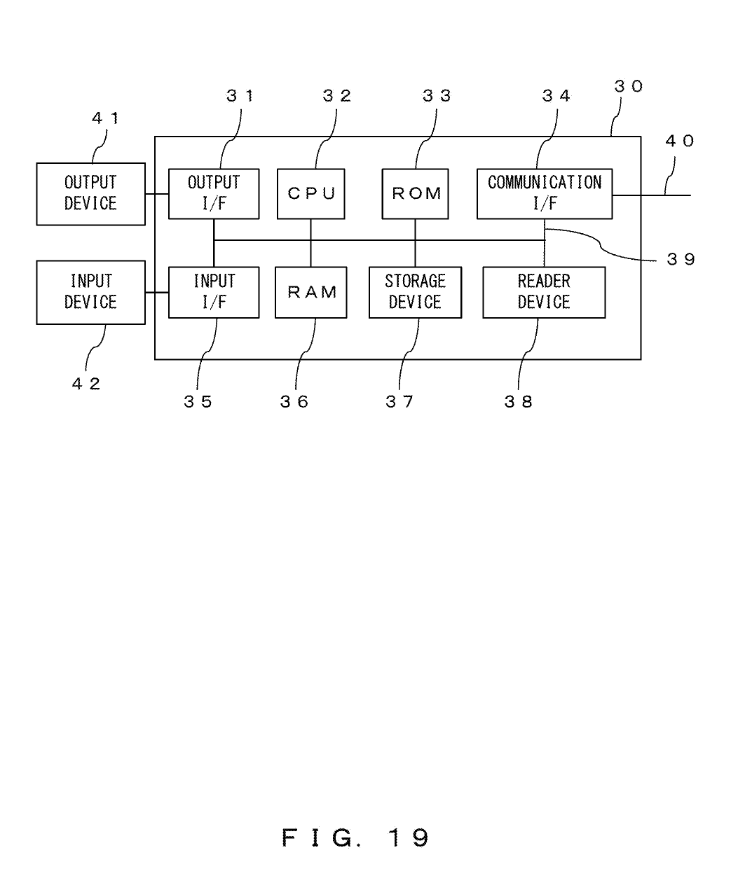

FIG. 19 is an example of a configuration block diagram of a hardware environment of a computer that executes programs according to the present embodiments. A computer 30 serves as the storage control device 1 or 11. The computer 30 is configured with CPU 32, ROM 33, RAM 36, a communication I/F 34, a storage device 37, an output I/F 31, an input I/F 35, a reader device 38, a bus 39, an output device 41, and an input device 42.

Here, CPU represents a central processing unit. ROM represents a read-only memory. RAM represents a random access memory. I/F represents an interface. The bus 39 are connected with CPU 32, ROM 33, RAM 36, the communication I/F 34, the storage device 37, the output I/F 31, the input I/F 35, and the reader device 38. The reader device 38 is a device to read out portable recording media. The output device 41 is connected to the output I/F 31. The input device 42 is connected to the input I/F 35.

Various forms of storage devices such as a hard disk, a flash memory, and a magnetic disk can be used as the storage device 37. The storage device 37 or ROM 33 stores programs according to the present embodiments that allows CPU 32 to serve as the monitoring unit 2, the adjustment unit 3 and the determination unit 4. More specifically, the storage device or ROM 33 stores programs according to the present embodiments that allow CPU 32 to serve as the hierarchical control unit 14. In addition, the storage device 37 or ROM 33 stores programs equivalent to the log-structured unit 13. The storage device 37 corresponds to the disk 31 according to the present embodiments.

RAM 36 temporarily stores information. RAM 36 corresponds to the memory 30 according to the present embodiments.

CPU 32 reads out programs according to the present embodiments from the storage device 37 or ROM 33, and executes the programs.

The communication I/F 34 is an interface such as a port for communicating with other devices by connecting through a network.

The programs that realize the processing explained in the above embodiments may be provided from a program provider through a communication network 50 and the communication I/F and stored in the storage device 37 as an example. Alternatively, the programs that realize the processing explained in the above embodiments may be commercially available and stored in a portable recording medium that is commercially distributed. In this case, the portable recording medium is set at the reader device 38, the programs are readout and executed by CPU 32. Various forms of recording media such as CD-ROM, a flexible disk, an optical disk, a magneto optical disk, an IC card, a USB memory device, and a semiconductor memory card can be used as the portable recording media. The programs stored in such a recording medium is read out by the reader device 38.

For the input device 52, a keyboard, a mouse, an electronic camera, a web camera, a microphone, a scanner, a sensor, a tablet, a touch panel and other devices can be used. In addition, for the output device 51, a display, a printer, a speaker and other devices can be used.

The network 50 may be a communication network such as the Internet, LAN, WAN, an exclusive line, a fixed line, a wireless line and others.

According to the technology described herein, it is possible to prevent storage areas in storage devices with high access performance from being occupied by data that may not be accessed in the future as a result of data update.

It should be noted that embodiments are not limited to the embodiments described above, but can take various structures or embodiments without departing from the scope of the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage control device, comprising
a processor configured to:
monitor access frequency of a write access and a read access each performed on each of a plurality of segments, the write access being performed between previous data reallocation and the present point in time with a write system that writes data in different write areas every time the data is updated, each of the write areas being associated with each of the plurality of segments that are units to logically manage data stored in a plurality of storage devices of different access performance;
adjust the access frequency by reducing the access frequency of one segment of the plurality of segments on which the write access is performed; and
determine one of the plurality of storage device to store data corresponding to the one segment with the adjusted access frequency on the basis of the adjusted access frequency.

2. The storage control device according to claim 1, wherein
the processor adjusts the access frequency by multiplying the access frequency of the one segment on which the write access is performed by an inverse number of a prescribed value.

3. The storage control device according to claim 1, wherein
the processor monitors an order of write access to the segments on which the write access is performed, and
based on the order of write access, the processor adjusts the access frequency by reducing the access frequency in a manner that the access frequency of a segment corresponding to the order of write access is further reduced as a period of time elapsed from a write access corresponding to the order of write access becomes longer.

4. The storage control device according to claim 1, wherein
the processor determines that data corresponding to a segment with the adjusted access frequency being higher is stored in a storage device with higher access performance.

5. A non-transitory computer-readable recording medium having stored therein a hierarchized storage control program from causing a computer to execute a process, the process comprising:
monitoring access frequency of a write access and a read access each performed on each of a plurality of segments, the write access being performed between previous data reallocation and the present point in time with a write system that writes data in different write areas every time the data is updated, each of the write areas being associated with each of the plurality of segments that are units to logically manage data stored in a plurality of storage devices of different access performance;
adjusting the access frequency by reducing the access frequency of one segment of the plurality of segments on which the write access is performed; and
determining one of the plurality of storage device to store data corresponding to the one segment with the adjusted access frequency on the basis of the adjusted access frequency.

6. A hierarchized storage control method to cause a computer to execute processing, the processing comprising:
monitoring, by a processor, access frequency of a write access and a read access each performed on each of a plurality of segments, the write access being performed between previous data reallocation and the present point in time with a write system that writes data in different write areas every time the data is updated, each of the write areas being associated with each of the plurality of segments that are units to logically manage data stored in a plurality of storage devices of different access performance;
adjusting, by the processor, the access frequency by reducing the access frequency of one segment of the plurality of segments on which the write access is performed; and
determining, by the processor, one of the plurality of storage device to store data corresponding to the one segment with the adjusted access frequency on the basis of the adjusted access frequency.
